(19) United States
(12) Patent Application Publication
(10) Pub. No.: US 2013/0010827 A1
(43) Pub. Date: Jan. 10, 2013

(54) TEMPERATURE INDICATOR FOR TEMPERATURE CHANGING MATERIAL OR MEANS AND METHOD FOR ITS PREPARATION

(75) Inventor: Juha Pimia, Varkaus (FI)

(73) Assignee: IITTALA GROUP OY AB, Helsinki (FI)

(21) Appl. No.: 13/637,097

(22) PCT Filed: Mar. 24, 2011
(86) PCT No.: PCT/FI2011/050248

§ 371 Date: Sep. 25, 2012

(30) Foreign Application Priority Data
Mar. 25, 2010 (FI) 20105303

(51) Int. Cl. G01K 11/12

(52) U.S. Cl. 374/162; 374/E11.018

(57) ABSTRACT

This invention relates to temperature indicators, particularly the invention relates to temperature indicators which can be used to indicate the temperature of temperature changing material or element. The disadvantages of prior art solutions include the toxicity of the material acting as an indicator or the poor ability to detect the colour change. In the solution according to the invention, the temperature indicator contains bismuth oxide and potentially one or more colouring pigments mixed into the bismuth oxide.

### TECHNICAL FIELD

This invention relates to temperature indicators, particularly the invention relates to temperature indicators which can be used to indicate the temperature of temperature changing material or means. The invention also relates to a method for the preparation of the material or means containing a temperature indicator.

### BACKGROUND OF THE INVENTION

Information concerning the temperature of the material is useful in many situations. For example, a cook using cooking dishes is often interested in knowing the temperature of the dishes he/she uses. Certain foods and certain preparation stages, for example, require a sufficiently hot pan or pot to be a success, but a dish which is too hot may in turn damage the coating of the dish or spoil the food which is being prepared.

Various thermochromic compounds are prior known for detecting the temperature on warm or hot surfaces. The colour of the thermochromic compound changes when the temperature changes; the colour change being either an abrupt change occurring at a certain temperature or a continuous, slowly occurring change as a function of the temperature. The changes can be either reversible or irreversible. The colour change of the thermochromic compounds based on the liquid crystal structure occurs typically at a certain temperature, often there is a very distinct change in colour. The colour change in many inorganic compounds, such as oxides and certain sulphides, is a continuous, reversible change. Many of these oxides and sulphide compounds are semiconductors, and their colour changes are due to the reduction of a so-called band gap as the temperature rises.

Many thermochromic compounds, which are in use, contain heavy metals, and because of their toxicity they cannot be used in utensils and dishes which are intended for the preparation or serving of food. The compounds CdS (cadmium sulphide) and CdSeS (cadmium selenide sulphide) which are commonly used as a bright red pigment, are extremely thermochromic compounds changing from bright red to brown as the temperature changes from room temperature to 250° C. However, the prior art use of the Cd-compounds as temperature indicators has a certain disadvantage; the ability of the human eye to detect the colour change from red to brown is poor, because the colour change in question is relatively small and the change occurs in the red wavelength range, where the human eye is least sensitive. FIG. 1 illustrates the relative colour sensitivity of the human eye in the daytime and at night. On the graphs shown, one can observe that in the red colour range (wavelengths 630 nm-760 nm) the colour sensitivity of the eye decreases significantly. In dim or poor light, it is especially difficult to detect the red colour, because the eye's colour sensitivity to detect red colour is the first to disappear when light is reduced.

Also the use of liquid crystal compounds is prior known. The problem with their use is their resistance to heat, which is usually limited to a temperature of 150° C. at the maximum, which complicates the use of the liquid crystal compounds in kitchen utensils, for example, because one should usually be able to use pots and pans which can tolerate temperatures of at least up to 200° C. or more.

U.S. Pat. No. 6,551,693 B1 discloses a temperature indication method which is applicable for cooking and frying dishes and which is based on iron oxide and perylene red. In this invention, the iron oxide acts as a thermochromic compound, becoming darker as the temperature rises, and the perylene red acts as a reference colour. Unfortunately the disadvantages of a layout like this include, for example, the indication of a single temperature as the iron oxide darkens and becomes the same colour as the reference colour, and a slight colour change which additionally occurs in the red wavelength range, which even further reduces the change which is detectable by the human eye, as described above. Furthermore, the limited heat resistance of the perylene red, 350° C. at maximum, and its tendency to fat-solubility make the application of this invention in practice, for example, for kitchen utensils, even more difficult. Because of the fat-solubility of the perylene red, one must try to locate the indicating figure under the protective layer of the coating, which in turn complicates the manufacture of this kind of product i.e. one which changes its colour as a function of temperature.

### SUMMARY OF THE INVENTION

The object of the present invention is to provide into a temperature changing material or means, a temperature indicator from which the above mentioned disadvantages have been eliminated or mitigated.

The object of the invention is achieved with the temperature indicator of a temperature changing material or means according to claim 1.

According to a preferable embodiment of the invention, bismuth oxide (Bi₂O₃) is used as a temperature indicator. According to another embodiment, bismuth oxide with colouring agent added into it is used as a temperature indicator. Both bismuth oxide and the mixture of bismuth oxide with colouring agent added into it have a colour change/colour changes which are clearly detectable by the human eye when the temperature of a temperature changing material changes, for example, between approximately 25° C.-400° C. It is to be noted that when mixing bismuth oxide with a colouring pigment, binding agent or some other matter, most preferably a mixture containing bismuth oxide is formed, and not a new, bismuth containing compound.

A temperature indicator according to the invention for visually indicating the temperature of a temperature changing material or means is characterized by what has been disclosed in the characterizing part of claim 1.

A method according to the invention for preparing the temperature indicator according to claim 1 is characterized by what has been disclosed in claim 13 concerning the method.

In this application, the term “temperature changing means” may refer to all such means whose temperature may change as a result of either heating or cooling, or means which, as a result of their use or, for example their contents, heat up and/or cool down. Such means include, for example, various dishes and means intended for the preparation and storing of foodstuffs, for example frying pans, pots, casseroles, oven dishes, grill plates, tongs/servers, cooking spatulas, serving dishes etc. or some other means, such as hot plates, kettles, toasters, ovens, sauna stoves, water boilers, electronical components and motors etc.

In this application, the term “temperature changing material” may refer to, for example, materials made of metal, glass, ceramics and/or plastic, of which the above mentioned temperature changing means can be manufactured.

The utility of the temperature indicator of the temperature changing material or means according to the present invention is based on numerous factors. It may be possible to use the temperature indicator in question for indicating more than a single temperature, the colour change which depends on the temperature of the material or means may correspond to the indicated temperature accurately and be clearly observable also without the reference colour. When different tones of blue are used in the temperature indicator, the human eye detects the colour change more readily than when tones of red are used. Furthermore, the colour change of the temperature indicator may be reversible, and most preferably it will resist many stages of heating and cooling. The temperature indicator may also have a high resistance to heat and chemicals, for example, in the temperature range which is usually used in cooking.

Additionally, the material or the mixture of materials used in the temperature indicator according to the invention is most preferably non-toxic, which means that the use of the temperature indicator in kitchen utensils, which are used for cooking, is safe, and the temperature indicator need not necessarily be coated or situated separately under a layer of coating or any other layer in the means or material. The preparation of the temperature indicator and incorporating it into kitchen utensils is also inexpensive and simple to implement.

Preferable embodiments of the invention are disclosed also in the independent claims.

### SHORT DESCRIPTION OF FIGURES

Preferable embodiments of the invention will now be described further with reference to the attached figures, in which

FIG. 1 illustrates the relative colour sensitivity of the human eye at night and during the day,

FIG. 2 shows the distribution of different colour tones in the CIELAB spatial colour diagram,

FIG. 3 shows different embodiments for use of the present invention by way of example,

FIGS. 4a-4d illustrate the colour values of bismuth oxide and bismuth oxide with different colouring agents added into it at different temperatures,

FIG. 5 shows a flowchart of the incorporation of the temperature indicator according to an embodiment of the present invention into a temperature changing material or means.

### DETAILED DESCRIPTION OF THE EMBODIMENTS

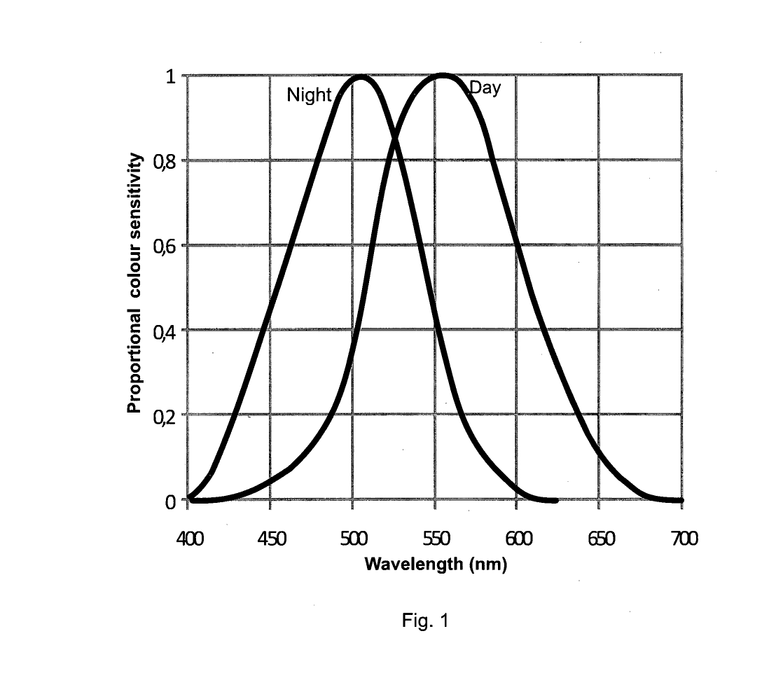

FIG. 1 has already been dealt with in the context of the prior art.

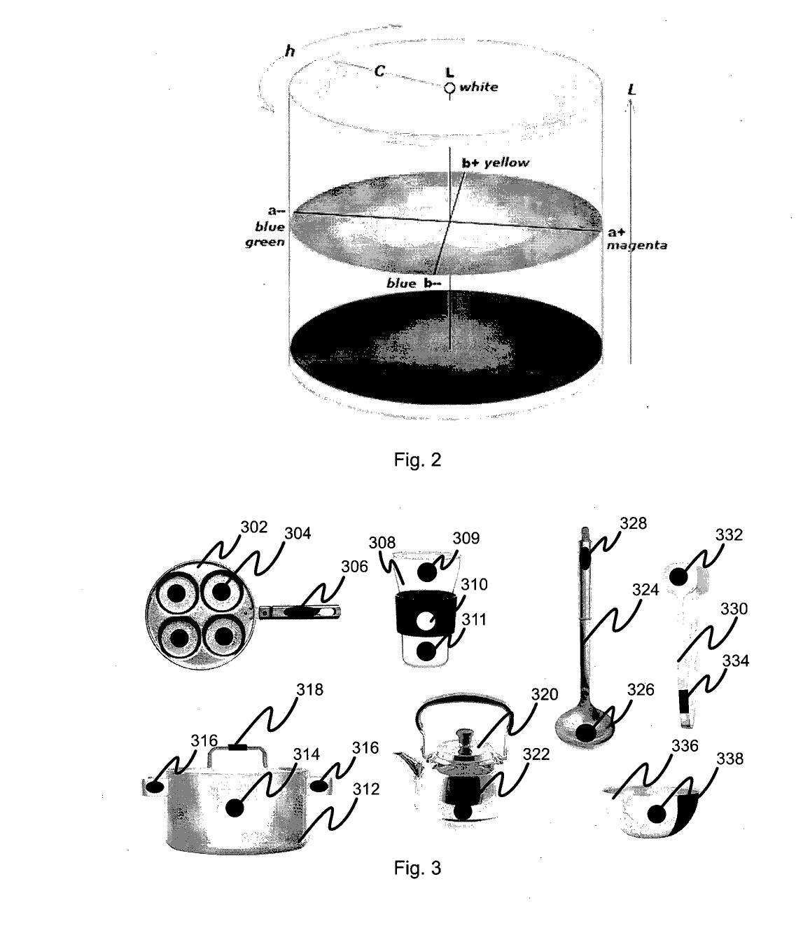

FIG. 2 shows the distribution of different colour tones in the CIELAB spatial colour diagram, in which the formation of colours has been divided into three separate components: channels L, a and b. Channel L corresponds to the brightness of the picture, i.e. in practice it means the proportion of black and white in the colour. Channel a in turn represents the change of the colour tone from green to red and channel b, from blue to yellow. When talking about colour tones in this document, the CIELAB values of the three channels are referred to as Lab values.

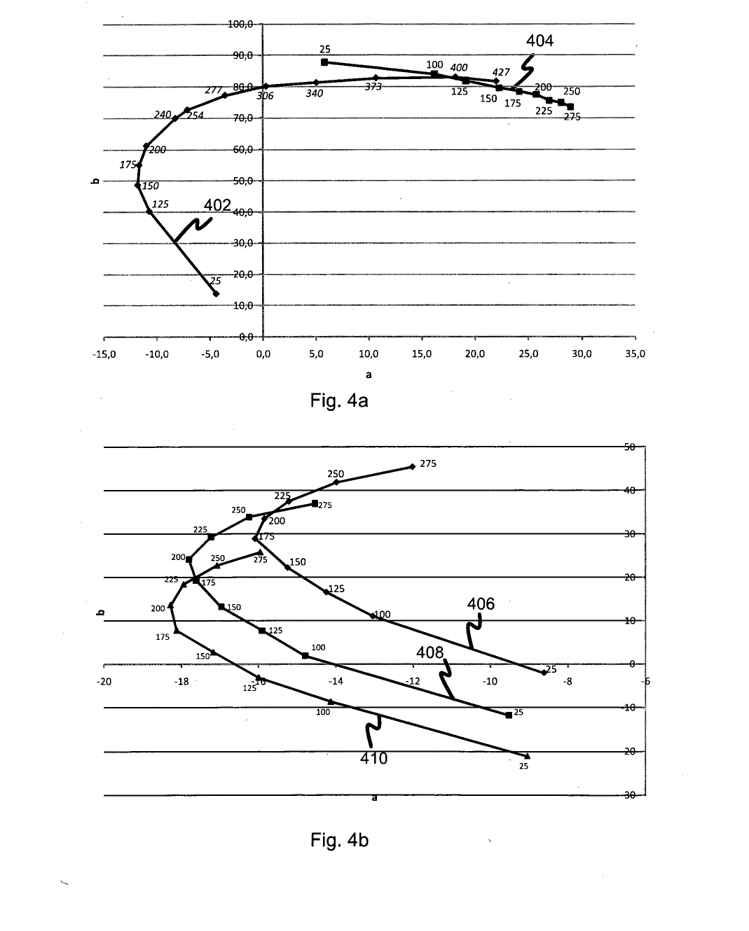

FIG. 3 shows embodiments for use of the present invention by way of example. The shown embodiments for use are only examples and are not in any way intended to restrict the use to which the invention can be put. The temperature indicator is suitable for use in temperature changing means, such as means associated with foodstuffs and cooking, for example, in frying pans, pots, casseroles, oven dishes, grill plates, tongs/servers, cooking spatulas and serving dishes, further also, for example, in hot plates, kettles, toasters, ovens, sauna stoves, boilers, electronic components and motors, and in the materials intended for use in their manufacture. Materials into which a temperature indicator/indicators can be added can be made of metal, glass, ceramic material and/or plastic.

There are absolutely no restrictions or limitations on the size, shape, number or positioning of the temperature indicators. In a certain embodiment, the temperature-indicating thermochromic compound is added to the material which will change temperature already during its manufacture and in this situation, the temperature changing material can be entire or else only a part of the temperature indicator. The indicator or indicators can be large, for example, the entire bottom of a pan or alternatively small areas in the material or means which indicates the temperature. The temperature changing material or means can also be coated in its entirety or alternatively only partially in the interior and/or exterior surface with the temperature-indicating thermochromic coating, or the material can be formed into a separate figure/figures. The figures which are formed can indicate not only the temperature but also the temperature distribution within the material or means and/or the figure/figures can create a decorative pattern/patterns in the temperature changing material or means. The shape of the temperature indicator can be round, square or it can form a ring running around the perimeter of the glass, bowl or pot etc. The indicator/indicators can be positioned anywhere on the temperature changing material or means, for example on the bottom, on a side wall, on the edge, on the outside surface, on a lid, handle and/or on knobs.

In the example shown in FIG. 3, potential positions of temperature indicators are shown in a temperature changing material or means. For example, a frying pan 302 can have a temperature indicator/indicators, for example, on the bottom 304 of the pan and/or on the handle 306. There can also be one or more temperature indicators on the bottom of the pan, for example, on the bottom of a blin or a pancake pan each cavity can have its own indicator or then the temperature indicator can be the size of the entire bottom. For example, on the bottom of a pan or a pot there can also be more than one indicators showing the temperature distribution of the pan's bottom. In that case, the temperature indicators can be arranged, for example, in a line from the centre towards the outer edge of the pan. The purpose of the indicators on the bottom is mainly to show the temperature, for example, the desired cooking temperature, to warn of excessive heating of the material and/or to indicate the temperature distribution on the bottom. The temperatures to be indicated can be chosen in many ways, depending on the purpose/purposes of use of the temperature indicator. For example, the temperature indicator on the bottom of a pan, pot, saucepan, etc. can be chosen in such a way that it indicates, for example, the temperatures 150° C.—light cooking, 200° C.—heavy cooking and 250° C.—the pan is too hot. The number and the distribution of the temperatures to be indicated can be chosen in some other way as well.

In the next example, temperature indicators have been added on a glass 308, on its lower edge 311, on its upper edge 309 and on the protective coating 310 running round the glass. The purpose of these indicators is to warn the user of the hot contents and/or to act, for example, as decorative elements. On pots, saucepans, kettles and bowls (examples 312, 320 and 336 in FIG. 3) temperature indicators can be added, in addition to the bottom, for example, to the sides 314, 322 and 338, to the handles 316 and to the lid 318. For example, the indicators on the handles and lids may warn the user not to burn his/her hands on the hot knobs. The temperature indicator can also act as a thermometer, for example, the temperature indicators 326 and 332 added to the ladle 324 and the tongs/servers 330, for example, can indicate the user of the food temperature and the temperature indicators 328 and 334 added to the handle parts can warn the user about hot utensils.

According to a certain embodiment, a single reference colour or more reference colours have been provided on a temperature changing material or means to facilitate the temperature indicating of the material or means. By means of the reference colour, a freely selected temperature can be indicated on the temperature changing material or means and one can, for example, observe whether the temperature of the dish is above or below the temperatures indicated by the reference colours. Depending on the embodiment, one or more reference colours can be used. By using a single reference colour, one can observe whether the temperature of the temperature changing material or means is higher, lower or equal to the temperature indicated by the reference colour. By using more reference colours, the number of the temperatures to be indicated can be increased. The composition of the pigment mixture used as a reference colour can be chosen such that its Lab colour values correspond to the Lab colour values of the temperature indicator used in a desired temperature to be indicated.

The shape, size or the place in the material or means of the reference colour/colours are not either limited in any way. The reference colour/colours can form, for example, a ring/rings around the temperature indicator and/or in its interior surface or then the reference colours can form, for example, “islands” in the interior and/or exterior surface of the temperature indicator. The reference colour/colours can also be incorporated into the temperature changing material or means and/or on their coating or a part of it. The reference colour/colours can also be arranged in some other way into the material or means, for example, some part or parts of the means, like for example, but not limiting, the handle of the frying pan or saucepan can have been provided with the same colour as the reference colour/colours. The user can also have a separate copy, for example a strip on which the reference colours are provided for comparing the temperature of the temperature changing material or means.

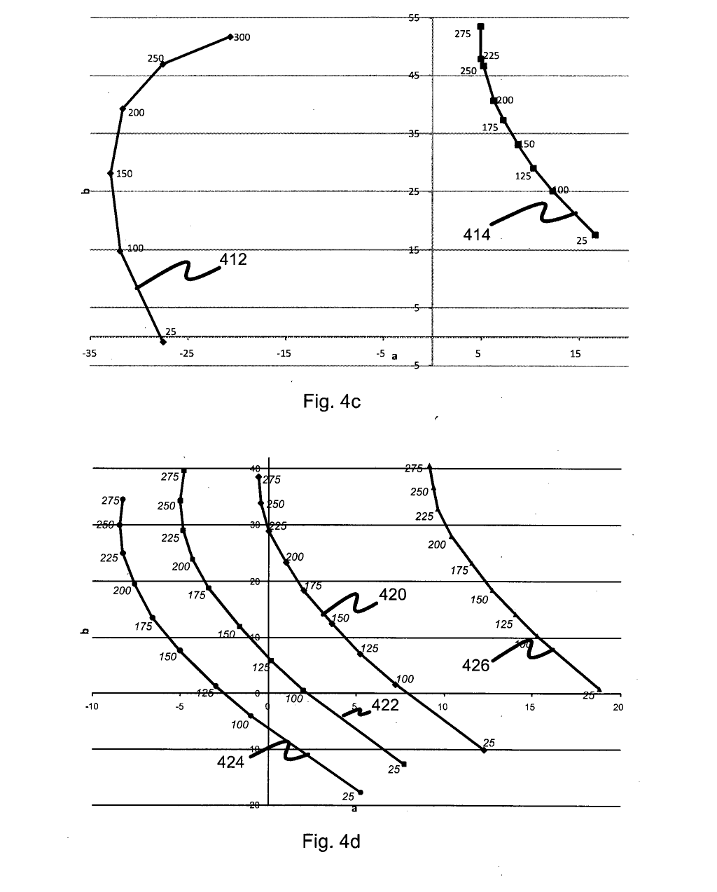

FIGS. 4a-4d illustrate the colour values of bismuth oxide and bismuth oxide with different colouring agents added into it at different temperatures. The coordinate axes of the diagram correspond to the values of the channels a and b in the CIELAB spatial colour diagram. The measuring points in turn correspond to the temperature values in the range of approx. 25° C.-300° C. In the diagram, the temperature at the measuring points has been marked on the point in question.

In FIG. 4a, curve 402 corresponds to the use of pure bismuth oxide (Bi₂O₃) as a temperature indicator. The granular size of the used bismuth oxide (Bi₂O₃) can be greater than that of a nanopowder, for example over 2500 nm, or it can have, for example, some other standard granular size greater than a nanopowder. As can be seen from the curve 402, the naturally yellow bismuth oxide is extremely light yellow in room temperature (approx. 20-25° C.), for example (Lab 90, −4, 12), and it changes to deep yellow at approx. 275° C., for example (Lab 87, −4, 77), and to light orange, for example (Lab 80, 11, 83), at approx. 300° C.-400° C. Thus, bismuth oxide can be used for indicating at least two or three temperature changes. Bismuth oxide can also be as a nanopowder, in which the particle size can be, for example, 100-2500 nm. The colour of bismuth oxide (Bi₂O₃) at different temperatures depends on the granular size as well, for as can be seen from the curve 404 in FIG. 4a, the corresponding colours with the nanopowder are at room temperature (approx. 20 25° C.) light orange, for example (Lab 89, 6, 88), at approx. 100° C. orange, for example (Lab 85, 16, 84) and at approx. 275° C. dark orange, for example (Lab 75, 29, 74).

Bismuth oxide can be safely used as a temperature indicator in kitchen utensils, because compared with many of the other thermochromic materials, it is non-toxic and has a high resistance to heat and chemicals. The colour change of bismuth oxide as a function of temperature is a reversible process, and it resists heating and cooling unchanged numerous times. Since the colour changes of bismuth oxide as a function of temperature in the range of 25° C.-400° C. are clearly detectable to the human eye (light yellow, deep yellow, light orange), it is possible to use the bismuth oxide according to the invention in question without a reference colour, but according to a certain embodiment, as has been described above, a reference colour/colours have been provided in a temperature changing material or means to make it easier to detect the colour change.

By mixing bismuth oxide with other colours, a series of different colours can be created which have a distinct, real colour change in the temperature range of approx. 25° C.-400° C., i.e. the colour changes as a function of temperature into another colour, it does not only become darker. With the mixtures used it can be possible to achieve even as good as approx. ±10%-15% temperature resolution. As a result, the colour changes can, when necessary, be detected also without the reference colour. Instead, the magnitude of the colour change makes it possible to indicate also small temperature changes by using reference colours. By using reference colours, one can detect colour differences in a thermochromic mixture even with approx. 10° C. temperature changes. The temperature range at which the colour changes are more clearly detectable, can be adjusted by the mixture ratio of the colours. By the mixture ratio, one can also adjust the intensity of the colours.

Different colouring agents which are to be mixed in the bismuth oxide, can be chosen to be non-toxic and their resistance to heat can be improved by adding some known heat resistant binding agent into them so that the heat resistance of the pigment agents is elevated, for example, beyond 400° C. As a binding agent, any binding agent may be used which is compatible with the coating material of the temperature changing material or means. Preferably the binding agent of the material used as a coating for the temperature changing material or means can be chosen for the binding agent of the pigments. The colour changes of the mixtures of the bismuth oxide and different colouring agents are also reversible, and the mixtures can be prepared to resist many heating and cooling times. Different colours of thermochromic mixtures can be provided, for example, in the ways which are described next.

### Example 1

In example 1, a deep blue pigment, for example cobalt aluminate blue spinel (Lab 42, 7, −53), which can be liquid or powder, is mixed into the bismuth oxide powder or paste (Bi₂O₃). The proportion of the deep blue pigment in the mixture can preferably be 0%-35%, more preferably 1%-8% and most preferably 4%-6%.

According to a certain embodiment, approx. 1% of the deep blue pigment is added into the bismuth oxide (Bi₂O₃) and a light blue colour, for example approx. (Lab 88, −9, −2), is obtained at room temperature (approx. 20-25° C.). At about 100° C., the mixture is light green, e.g. approx. (Lab 88, −13, 11), and at about 200° C. it is yellowish green, e.g. approx. (Lab 87, −16, 34) (see FIG. 4b, curve 406).

According to another embodiment, approx. 4% of the deep blue pigment is added into the bismuth oxide (Bi₂O₃) and a light blue colour, for example approx. (Lab 79, −10, −12), is obtained at room temperature (approx. 20-25° C.), and at about 100° C. it is green-blue, e.g. approx. (Lab 79, −15, −9), and at about 200° C. it is green, e.g. approx. (Lab 78, −18, 24) (see FIG. 4b, curve 408).

According to a further embodiment, approx. 8% of the deep blue pigment is added into the bismuth oxide (Bi₂O₃) and a light blue colour, for example “Carolina blue” (Lab 72, −9, −21), is obtained at room temperature (approx. 20-25° C.), and at about 100° C. it is green-blue, e.g. approx. (Lab 72, −14, −9), and at about 175° C. it is green, e.g. approx. (Lab 71, −18, 8) (see FIG. 4b, curve 410).

### Example 2

In example 2, a blue-green pigment, e.g. cobalt chrome blue-green spinel (Lab 62, 38, −23), which can be liquid or powder, is mixed into the bismuth oxide powder or paste (Bi₂O₃). The proportion of the blue-green pigment in the mixture can preferably be 0%-35%, more preferably 2%-8% and most preferably 4%-6%.

According to a certain embodiment, approx. 2% of a blue-green pigment is added into the bismuth oxide (Bi₂O₃) and a bright turquoise colour, e.g. approx. (Lab 84, 28, −1), is obtained at room temperature (approx. 20-25° C.). As the temperature rises, for example up to about 150° C., the colour changes to green, e.g. approx. (Lab 82, −33, 28), and finally, at approx. 250° C., the mixture is yellowish green, e.g. approx. (Lab 79, −28, 47) (see FIG. 4c, curve 412).

### Example 3

In example 3, a red pigment, for example iron oxide red (Lab 75, 18, 16), is mixed into the bismuth oxide powder or paste (Bi₂O₃). The proportion of the red pigment in the mixture can preferably be 0%-15%, more preferably 0.1%-10% and most preferably 0.5%-1%.

According to a certain embodiment, approx. 0.5% iron oxide is added into the bismuth oxide (Bi₂O₃) and a light pink colour, e.g. approx. (Lab 76, 17, 18), is obtained at room temperature (approx. 20-25° C.), and it changes to light orange as the temperature rises above 100° C., e.g. approx. (Lab 73, 9, 33-70, 5, 53), to about 150° C.-275° C. (see FIG. 4c, curve 414).

Other similar pink-orange changes can be achieved with deep red pigments, for example by incorporating Paliogen 3880.

### Example 4

According to still another embodiment, a violet pigment, e.g. (Lab 38, 18, −31) is added into the bismuth oxide powder or paste (Bi₂O₃). FIG. 4d shows the colour values of the mixture/mixtures of bismuth oxide and the violet and/or blue/red pigment at different temperatures. The proportion of the violet pigment in the mixture can preferably be 1%-30%, most preferably 15%-25%. Colours can thus be provided which are light violet at room temperature (approx. 20-25° C.). The curve 420 in FIG. 4d illustrates the mixture of bismuth oxide and violet, in which there is 22% of the violet pigment, in curve 422 there is 15% of the violet pigment. These mixtures have a light violet colour, e.g. approx. (Lab 68, 12, −10) at room temperature. The colour of these mixtures changes e.g. at about 200-250° C. to yellow, e.g. (Lab 68, 0, 29), as shown in FIG. 4d by the curve 420.

By adding an intensely blue colour (Lab 42, 7, −53) into the mixture of bismuth oxide and violet, the colour tone of the thermochromic mixture can be changed into a more green direction, like the curve 424 in FIG. 4d, where there is 15% of violet and 4% of blue. Also intensely red, e.g. (Lab 42, 56, 32), can be added into the mixture of bismuth oxide and violet, as in the curve 426 in FIG. 4d, where there is 15% of violet and 0.4% of red. The proportion of the blue pigment in the mixture can preferably be 0.1%-15%, most preferably 2%-8%, and the proportion of the red pigment in the mixture can preferably be 0.05%-5%, most preferably 0.1%1%.

Other colour combinations can be obtained by using, for example, the above mentioned colours combined with the nanopowder of bismuth oxide. The above mentioned proportions of the mixtures of colours are merely examples, and it will be clear to a person skilled in the art that they can be changed if necessary.

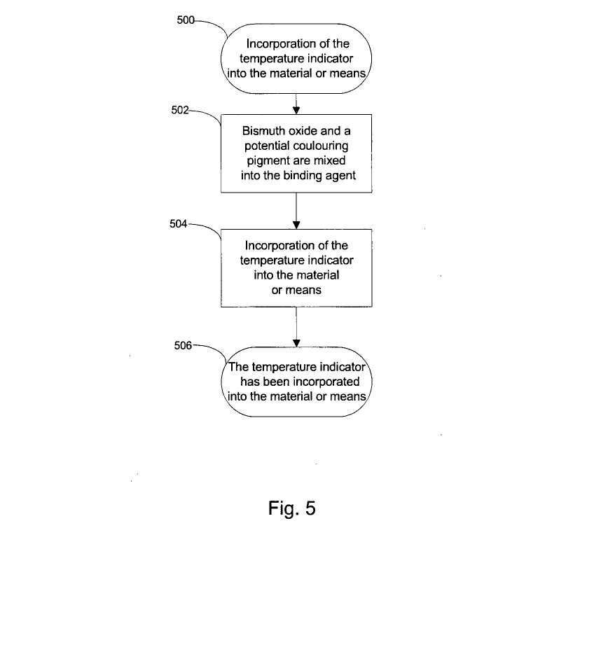

FIG. 5 illustrates a flowchart according to one embodiment of the present invention demonstrating the incorporation of the temperature indicator into the temperature changing material or means 500. During phase 502, bismuth oxide (Bi₂O₃) and the potential colouring pigment are mixed into a binding agent. The potentially used colouring pigment and the amount of colouring pigment will depend on the embodiment, such that one obtains the desired colour with the bismuth oxide at room temperature and the desired colour changes when the temperature changes. One embodiment involves only bismuth oxide with no addition of colouring agent. The potentially used binding agent is chosen so that the pigmenting agent's temperature resistance may be improved and also that the binding agent is compatible with the material used for coating for the temperature changing material or means. The binding agent can thus be, for example, the binding agent of the material used for coating the temperature changing material or means.

In phase 504, the temperature indicator is incorporated into the temperature changing material or means. In the embodiment where the temperature indicator is incorporated into the temperature changing material itself, a temperature indicating powder or paste prepared in phase 502 is mixed with the material prior to its preparation, e.g. into a plastic before it is set in the mould or undergoes some corresponding procedure. In the embodiment where the temperature indicator is incorporated into the coating of the temperature changing material or means, the temperature indicating powder or paste is mixed with a coating agent and the coating of the temperature changing material or means is performed. One should note that in phases 502 and 504, the mixing of the different materials can take place simultaneously.

The temperature indicator can also create a figure on the surface of the temperature changing material or means and/or on the surface of the coating and/or in the case of multiple layer coatings, between some of the coating layers of the material. For example, in a temperature changing means which is coated with PTFE (polytetrafluoroethylene, “Teflon”) or some corresponding plastic-like compounds, the layers can be arranged such that on top of the aluminium base there is a black so-called primer layer and on top of it there is a clear topcoat layer. Then the temperature indicator could be situated between the primer and the topcoat layers. In these embodiments, patterning can be achieved, for example, by spraying through a template or stencil, by imprinting or attaching into the temperature changing means a separate part which already contains a figure. In phase 506 the temperature indicator has been incorporated into the temperature changing material or means (phase 506).

The scope of the invention is defined in the following claims. However, it will be clear to a person skilled in the art that the details of the different features of the invention can vary within the inventive spirit depending on each embodiment of the invention.

Although the above description refers mainly to the use of the temperature indicator in utensils or materials associated with the preparation of food and foodstuffs, it is possible that the temperature indicating material can be used in other means as well, for example in hot water kettles, toasters, the hot plates on electrical cookers, ovens, motors, sauna stoves, boilers, electronic components etc. in other words all equipment which change their temperature or which are subjected to changes in temperature and which need to be handled by the user. For example, the temperature indicators which are incorporated into different parts of a motor can inform the user about the temperature of the different parts and they can also provide information about possible faults and also which parts of the motor can be handled safely by the user with no risk of heat-induced injury. Similarly, if temperature indicating materials are incorporated into the hot plates of an electrical cooker or its oven, this can inform the user of their temperature thus preventing possible injury, for example by indicating a hotness of a hot plate which has been left on by mistake. The temperature indicators can be placed in both the inside and outside surfaces of an oven. The indicators inside the oven inform the user about the temperature distribution inside the oven; the outside surface indicators in turn provide information about the surface temperature and thus can warn the user to avoid burning themselves on the hot surfaces. The same principle is involved should these materials be incorporated into sauna stoves, water boilers, etc. in other words equipment which change their temperature, in order to provide the user information about the temperature of the equipment and which parts of are hot and also about the distribution of heat in the different parts of the equipment.

1. A temperature indicator for visually indicating the temperature of a temperature changing material or means, characterized in that the temperature indicator comprises bismuth oxide (Bi₂O₃).

2. The temperature indicator according to claim 1, wherein the temperature indicator comprises a colouring pigment mixed into the bismuth oxide (Bi₂O₃) for changing the temperature indicator's colour which depends on the temperature and/or for intensifying the colour change as the temperature of the material changes.

3. The temperature indicator according to claim 2, wherein the colouring pigment mixed into the bismuth oxide (Bi₂O₃) is of deep blue, blue-green, red or turquoise blue colouring pigment or a mixture of any of them.

4. The temperature indicator according to claim 3, wherein the deep blue pigment is cobalt aluminate blue spinel, the blue-green one is cobalt chrome blue-green spinel and the red one is iron oxide.

5. The temperature indicator according to claim 2, wherein the colouring pigment mixed into the bismuth oxide (Bi₂O₃) is non-toxic.

6. The temperature indicator according to claim 1, wherein the temperature indicator comprises a binding agent which corresponds to the binding agent used for the coating of the temperature changing material.

7. Temperature changing material, wherein the material comprises bismuth oxide (Bi₂O₃) and/or a colouring pigment mixed into the bismuth oxide (Bi₂O₃) for changing the colour of the material which acts as a temperature indicator and/or for intensifying the colour change as the temperature of the material changes.

8. Temperature changing means, wherein the means comprises the temperature indicator according to claim 1 for visually indicating the temperature of said means.

9. Means according to claim 8, wherein the means is means intended for the preparation and storing of foodstuffs, for example, a frying pan, pot, casserole, oven dish, grill plate, tongs/servers, cooking spatula, serving dish or other means, for example a hot plate on the stove, kettle, toaster, oven, sauna stove, water boiler, electronic component, motor.

10. Means according to claim 8, wherein a separate figure/figures have been formed on the means by the temperature indicator.

11. Means according to claim 8, wherein, in addition to the temperature indicator, a reference figure of a single colour or more colours has been formed on the means to facilitate the detection of the temperature change.

12. Means according to claim 8, wherein the temperature indicator is located on the bottom, edge, handle/knobs and/or lid of the means.

13. Method for preparing the means according to claim 8, characterized in that the method comprises:
the preparation of the temperature indicator from bismuth oxide (Bi₂O₃) or from the mixture of bismuth oxide and a colouring pigment,
incorporation of the temperature indicator into a temperature changing material, comprising bismuth oxide (Bi₂O₃) and/or a colouring pigment mixed into the bismuth oxide (Bi₂O₃) for changing the colour of the material which acts as a temperature indicator and/or for intensifying the colour change as the temperature of the material changes.

14. Method according to claim 13, characterized in that the temperature indicator is incorporated into the material by mixing the temperature indicator into the material which is to be heated and/or which heats up and/or on the coating of the material which is to be heated and/or which heats up.

15. Method according to claim 13, characterized in that the temperature indicator is incorporated into the means by spraying, or by imprinting the temperature indicator under, between and/or on top of the coating layer or layers, or wherein the temperature indicator is connected to the means via a separate part which is attached to the means.
